(19) United States
(12) Patent Application Publication
(10) Pub. No.: US 2025/0368545 A1
(43) Pub. Date: Dec. 4, 2025

(54) MANUAL WATER FILTRATION SYSTEM AND METHOD

(71) Applicant: Mohssen Ghiassi, Newport Beach, CA (US)

(72) Inventor: Mohssen Ghiassi, Newport Beach, CA (US)

(21) Appl. No.: 19/081,656

(22) Filed: Mar. 17, 2025

Related U.S. Application Data
(60) Provisional application No. 63/731,685, filed on May 31, 2024.
(60) Provisional application No. 63/833,152, filed on Oct. 29, 2024.

(51) Int. Cl. C02F 1/00; C02F 103/02

(52) U.S. Cl. CPC C02F 1/003; C02F 2103/02; C02F 2201/004; C02F 2201/006; C02F 2201/007; C02F 2301/066; C02F 2307/04; C02F 2307/10

(57) ABSTRACT

A manual water filtration system and method for filtering water through a pressure driven filtration mechanism. The system includes a pitcher, a lid, and a handle functionally connected to a filtration mechanism by a series of guide rods. The filtration mechanism includes a seal that forms a watertight seal within the pitcher and a filter cartridge. A user can fill the pitcher with unfiltered water, then drive the filtration mechanism into the unfiltered water, forcing the unfiltered water through the filter cartridge.

### RELATED APPLICATIONS

The present disclosure claims to the benefit of U.S. Provisional Application Ser. No. 63/731,685, filed May 27, 2024, and U.S. Provisional Application Ser. No. 63/833,152 filed Oct. 10, 2024, which are hereby fully incorporated by reference in their entirety.

### TECHNICAL FIELD

The present invention relates generally to water purification, more specifically a pressure filter water filtration reservoir.

### BACKGROUND

Environmental and industrial factors have led to an increased need and desire for personal water filtration systems and methods. Water filtration in homes and office are generally accomplished through filters in refrigerators, whole-house filters, or under the sink filtration. Current manual filtration systems include the economically popular filtration pitchers.

Filtration pitchers generally include a fill tank containing a filter cartridge on top and a pure water container at the bottom. Unfiltered water is poured into the fill tank, and gravity pulls the unfiltered water through the filter cartridge. A common issue for these pitchers is a lengthy fill time, where the user must wait for the water to slowly filter through the tank and drip filtered water into the pure water section. Some units can take ten minutes or more to obtain a full tank of pure water.

These gravity filters also limit the water purity that can be achieved. More effective filters have lower porosity membranes, but low porosity membrane filters contribute to even longer fill times. Accordingly, there is a need for an improved manual water filtration system that is more efficient and can utilize more effective filters.

### SUMMARY

The present invention relates to a manual water filtration reservoir designed to solve the aforementioned problems and enhance water purification systems available to consumers by utilizing pressure-driven filtration. The system can comprise a pitcher, a lid with a handle, a series of guides, and a filtration mechanism. The filtration mechanism can comprise a seal and a filter cartridge. The filtration mechanism is configured to fit within the pitcher and the lid is configured to sit on or within an opening of the pitcher. The system is configured such that the guide rods functionally connect the handle to the filtration mechanism, such that when pressure is applied to the handle, the filtration mechanism is driven down into the pitcher.

To use the system, a user first fills the pitcher with unfiltered water. Then, the user applies pressure to the handle, driving the filtration mechanism into the unfiltered water. The seal prevents the unfiltered water from escaping around the filtration mechanism, instead forcing the unfiltered water through the filter cartridge. As the unfiltered water passes through the filter cartridge, the unfiltered water is purified into filtered water. The filtered water emerges out of the filter cartridge and the pitcher fills with filtered water until no unfiltered water remains.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is an exploded view of a system for water purification, according to an exemplary embodiment;

FIG. 1B is a perspective view of a system for water purification, according to an exemplary embodiment; and

FIG. 1C is a perspective view of a system for water purification, according to an exemplary embodiment.

FIG. 1D is a perspective view of a system for water purification, according to an exemplary embodiment.

FIG. 2 is a perspective view of a filtration cartridge of a system for water purification, according to an exemplary embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

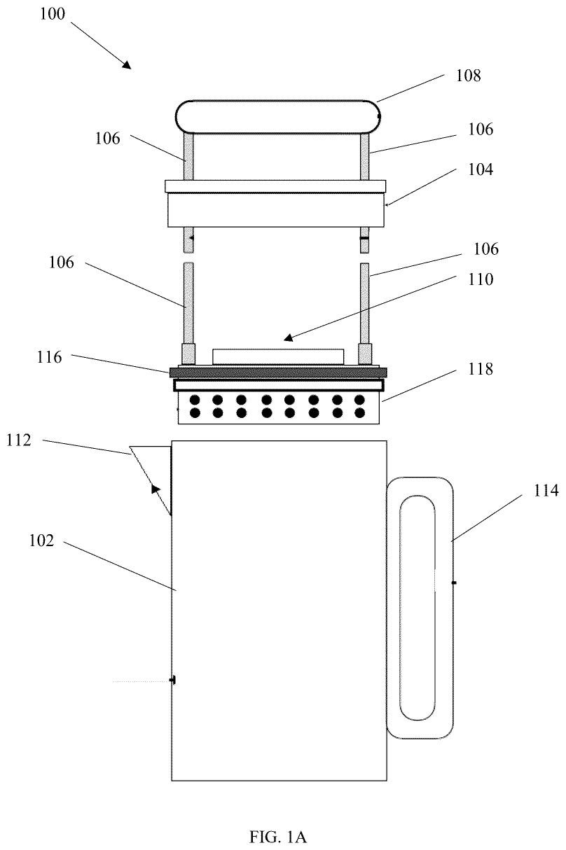

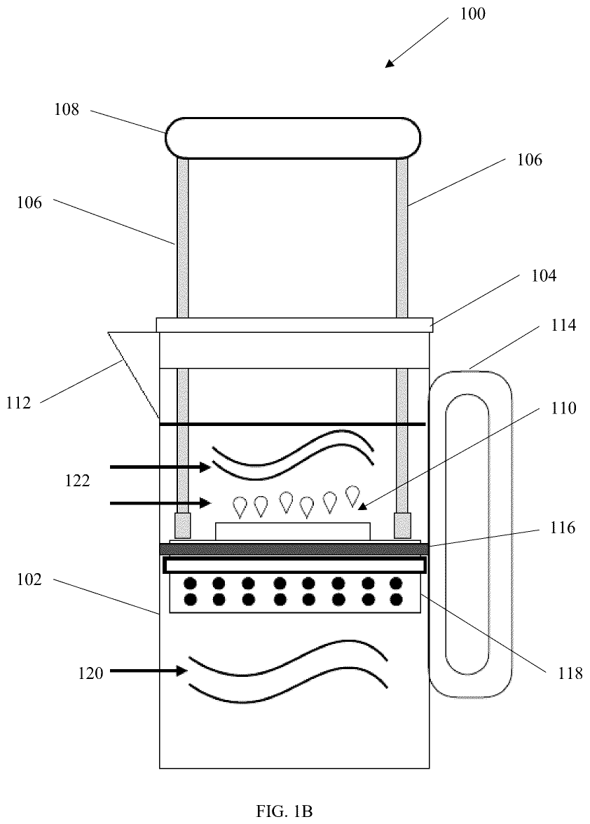

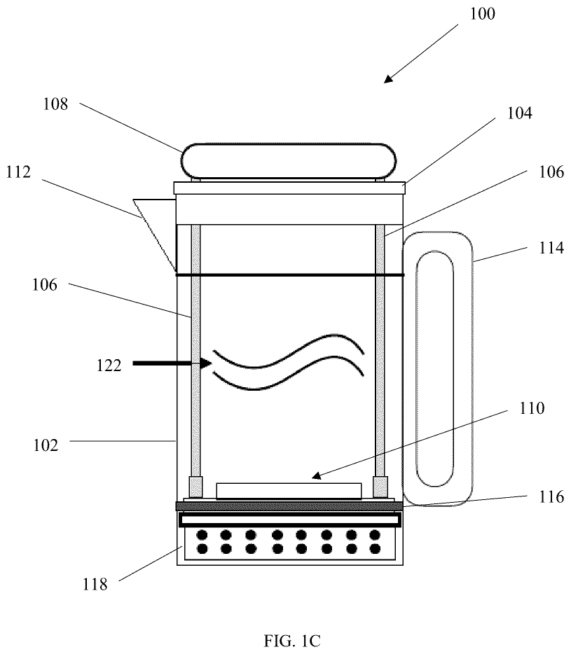

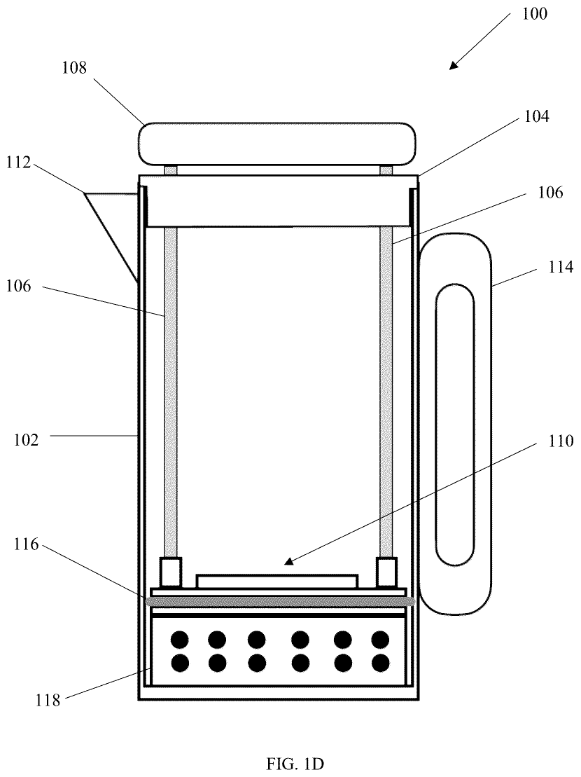

Embodiments and methods disclosed herein can include a manual water filtration reservoir. The manual water filtration reservoir can comprise a reservoir, a reservoir lid, and a filtration mechanism. FIGS. 1A-1D depict an exemplary embodiment of a manual water filtration system 100. The system 100 comprises a pitcher 102, a lid 104, a series of guide rods 106, a lid handle 108, and a filtration mechanism 110.

The pitcher 102 can comprise a spout 112 and a handle 114. The pitcher 102 can comprise any suitable material, including but not limited to polymer, metal, or glass fit to hold potable water. The pitcher 102 can have a mouth and a base. It is contemplated that the pitcher 102 can have any suitable geometries, including, but not limited to, circular, square, rectangular, pentagonal, and hexagonal.

The lid 104 is configured to fit on or within the mouth of the pitcher 102. The lid 104 can comprise any suitable material, such as polymer or metal. The geometry of lid 104 will generally follow the geometry of the pitcher 102. The lid 104 is configured such that the guide rods 106 can pass freely through the lid, such that the lid 104 can be moved, manually or by gravitational force, to cover the mouth of the pitcher 102. The lid 104 can be configured to “lock” onto the mouth of the pitcher 102 by suitable features, including, but not limited to, a press-fit or a snap-fit embodiment.

The filtration mechanism 110 comprises a seal 116 and a filter cartridge 118. The seal 116 is configured to form a watertight seal within the pitcher 102. The filter cartridge 118 comprises a top side and a bottom side. The bottom side of the filter cartridge 118 is configured to receive unfiltered watered. The top side of the filter cartridge 118 is configured to release filtered water that has passed through the filter cartridge 118. The filter cartridge 118 can be configured to remove various contaminants, including bacteria, viruses, and chemicals, from water that passes through the filter cartridge 118. The filter cartridge 118 can be pleated or other suitable configurations. Some embodiments of the filter cartridge 118 may be of such small porosity that water can only pass through when the water is forced through the filter cartridge 118 with applied pressure.

The series of guide rods 106 can connect the filtration mechanism 110 to the lid 104. In embodiments, the lid 104 is configured such that the series of guide rods 106 are affixed to the filtration 110 mechanism and the guide rods 106 extend through a series of holes (not pictured) in the reservoir lid 104 to connect with the lid handle. The guide rods 106 can be permanently or removably affixed to the lid handle 108. In the exemplary embodiment, the lid 104 is configured to move freely along the guide rods 106, such that the lid 104 automatically falls to cover the mouth of the pitcher 102 when the filtration mechanism 110 is inserted into the pitcher 102. When the lid 104 covers the mouth of the pitcher 102, the lid 104 can be configured to stabilize the movement of the guide rods 106

In an exemplary use of the system 100, as depicted in FIGS. 1B-1D, a portion of unfiltered water 120 is poured into the pitcher 102. Because of the configuration of the guide rods 106, the filtration mechanism 110 can be arranged into a “starting position”, so that the filtration mechanism is in close proximity to the reservoir lid 104. A user can pull on the lid handle 108 to move the guide rods 106 through the lid 104, until the filtration mechanism 110 is in this starting position. This starting position is advantageous because when the filtration mechanism 110 is fit into the pitcher 102, the filtration mechanism 110 is entirely above the unfiltered water 120 within the pitcher 102.

Once the filtration mechanism is fit within the pitcher 102, the lid 104 is configured to move freely along the guide rods and can be fit onto the mouth of the pitcher 102. The user can lower the lid 104 or the lid 104 can automatically fall into place to cover the pitcher 102. The lid 104 is configured to “lock” into the mouth of the pitcher, such that the guide rods 106 are stabilized during the filtration process. The system 100 is then ready to begin the filtration process.

The user can apply pressure to the lid handle 108, which in turn drives the filtration mechanism 110 into the unfiltered water 120. As noted above, the lid 104 locks the guide rods 106 into a particular configuration within the pitcher 102, such that the guide rods 106 are stabilized during the descent of the filtration mechanism 110 into the pitcher 102. As the filtration mechanism 110 is driven into the unfiltered water, the seal 116 prevents any unfiltered water 120 from being directed anywhere except into the filter cartridge 118. The pressure of the filtration mechanism 110 being driven into the pitcher 102 forces the unfiltered water 120 through the filter cartridge 118. Once the unfiltered water 120 is forced through the bottom portion of the filter cartridge 118, filtered water 122 emerges on the top side of the filter cartridge 118. The lid handle 108 can be lowered completely, such that all of the unfiltered water 120 is forced through the filter cartridge 118. The user can then use the system 100 as a standard water pitcher and pour filtered water 122 from the spout 112. The filtration mechanism 110 remains at the bottom of the pitcher 102, as depicted in FIG. 1D, until the filtered water has been drained from the system 100.

Advantageously, the use of pressure to force the unfiltered water 120 through the filter cartridge 118 allows for the use of more effective filter cartridges, compared to traditional gravity filter pitchers. The filter cartridges 118 of the system 100 can comprise tighter membranes than gravity filters, removing more impurities from the unfiltered water. It is contemplated that the filter cartridge 118 can be configured to be periodically replaced by the user. In some embodiments, the entire filtration mechanism 110 can be configured to be replaced by the user, as the seal 116 and the filter cartridge 118 may wear out over time and frequent use.

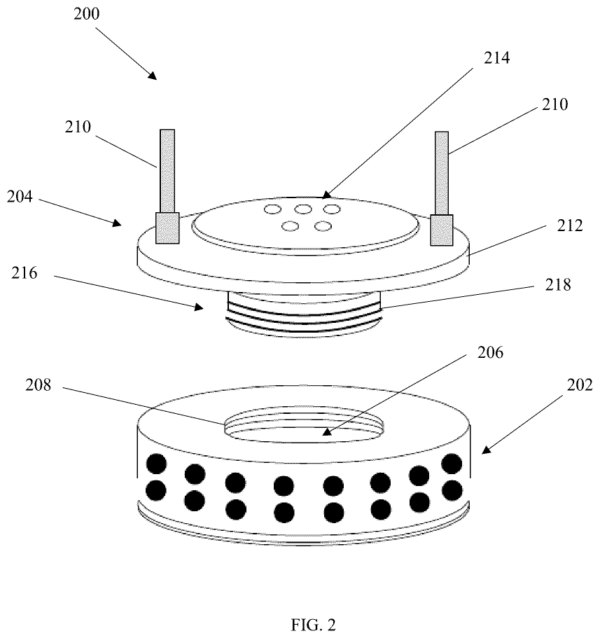

In some embodiments, the filter cartridge can comprise a housing and a filter, such as the exemplary embodiment depicted in FIG. 2. In such embodiments, the filter can be periodically removed and replaced within the housing to ensure the effectiveness of the system 100. The filter is configured to remove contaminants from water, such as bacteria, viruses, and/or chemicals.

In the exemplary embodiment depicted in FIG. 2, a filtration mechanism 200 comprises a filter 202 and a housing 204. The filter 202 comprises a filter attachment point 206. The housing 204 comprises a seal 212, a fluid outlet 214, and a housing attachment point 216. The filter attachment point 206 and the housing attachment point 216 are configured to mate. In the exemplary embodiment, the filter attachment point 206 comprises a set of threads 208, torqued in one direction, and the housing attachment point 204 comprises a set of threads 218 torqued in the opposing direction, such that the housing attachment point 204 can be screwed into the filter attachment point 206. In other embodiments, the filter attachment point 206 and the housing attachment point 204 can comprises other features configured such that the filter 202 can removably mate with the housing 204, such as a press-fit configuration, a snap-fit configuration, a series of tabs, quick-release fasteners, or other specialized mechanical fasteners. The filter 202 can be detached and replaced with a new filter as needed, such that the lifetime of the system described herein can be extended potentially indefinitely.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A system for water purification comprising:
a reservoir comprising a mouth, a body, and a base;
a lid configured to fit on or within the mouth of the reservoir;
a lid handle;
a filtration mechanism comprising a seal and a filtration cartridge, wherein the filtration mechanism is configured to fit within the body of the reservoir; and
a plurality of guide rods connected to the lid handle and the filtration mechanism such that an application of downward pressure on the lid handle moves the filtration mechanism into the body of the reservoir.

2. The system for water purification of claim 1, wherein the reservoir comprises a spout and a handle.

3. The system for water purification of claim 1, wherein the lid comprises a series of holes configured to receive the plurality of guide rods.

4. The system for water purification of claim 3, wherein the plurality of guide rods are configured to move freely through the series of holes in the lid.

5. The system for water purification of claim 1, wherein the seal forms a watertight seal in the body of the reservoir.

6. The system for water purification of claim 1, wherein the filtration cartridge is configured to remove contaminants from water passing through the filtration cartridge, including bacteria, viruses, chemicals, or any combination thereof.

7. The system for water purification of claim 1, wherein the filtration cartridge is configured to be replaced by a new filtration cartridge.

8. The system for water purification of claim 1, wherein the filtration cartridge comprises a filter housing and a filter configured to fit within the filter housing.

9. The system for water purification of claim 8, wherein the filter is removably affixed within the filter housing.

10. The system for water purification of claim 1, wherein the plurality of guide rods comprises two guide rods.

11. A method for filtering water, the method comprising:
filling a reservoir with raw water;
inserting a reservoir top into the reservoir, the reservoir top comprising a piston filter mechanism, a series of guide rods affixed to the piston filter mechanism on one end of the guide rods, a lid with a series of holes configured to receive the series of guide rods such that the guide rods extend through the lid, and a lid handle affixed to a second end of the guide rods;
applying pressure to the lid handle, such that the piston filter mechanism is driven towards the raw water;
forcing the raw water through the piston filter mechanism;
filtering the raw water to remove impurities as the raw water, such that filtered water emerges from the piston filter mechanism; and
continuing to apply pressure and force the raw water through the piston filter mechanism until the reservoir is filled with filtered water or all of the raw water has been filtered.

12. The method for filtering water of claim 11, wherein the piston filter mechanism comprises a watertight seal configured to fit within the reservoir and a filter cartridge configured to removed impurities from raw water.

13. The method for filtering water of claim 11, wherein the piston filter mechanism is configured to remove contaminants from water passing through the filtration cartridge, including bacteria, viruses, chemicals, or any combination thereof.

14. The method for filtering water of claim 11, the method further comprising sliding the lid down the guide rods to fit into a top opening of the reservoir.

15. A manual water filter reservoir, the water filter reservoir comprising:
a reservoir comprising a bottom and a mouth;
a reservoir lid, wherein the reservoir lid further comprises a handle; and
a filtration mechanism affixed to the handle by a series of guide rods, wherein the series of guide rods extend through the reservoir lid to an attachment point on the handle and wherein the filtration mechanism comprises a seal and a filtration cartridge configured to fit within the reservoir such that the filtration cartridge is situated closest to the bottom of the reservoir and the lid is situated on or in the mouth of the reservoir.

16. The manual water filter reservoir of claim 15, wherein the reservoir lid is configured to move freely along the guide rods.

17. The manual water filter reservoir of claim 15, wherein the seal forms a watertight seal within the reservoir.
